(19) United States
(12) Patent Application Publication
(10) Pub. No.: US 2013/0159130 A1
(43) Pub. Date: Jun. 20, 2013

(54) Method of Electronically Conducting Virtual Exchange Under Negotiation of Goods and Services in a System Over a Communication Network

(71) Applicants: Vivek GAUR, Delhi (IN); Sandeep SHARMA, Delhi (IN)

(72) Inventors: Vivek GAUR, Delhi (IN); Sandeep SHARMA, Delhi (IN)

(73) Assignee: VAS DATA SERVICES PRIVATE LIMITED, Delhi (IN)

(21) Appl. No.: 13/528,117

(22) Filed: Jun. 20, 2012

(30) Foreign Application Priority Data
Jun. 30, 2011 (IN) 1858/DEL/2011

(51) Int. Cl. G06Q 30/06

(52) U.S. Cl. CPC G06Q 30/0611
USPC 705/26.4

(57) ABSTRACT

The invention relates to a method of electronically conducting virtual exchange under negotiation of goods and services in a system over a communication network, the system comprising: web server displaying the detailed data in respect of exchangeable commodity or services; a hand-held device enabled to access the web server via internet, the device having at least one input means, a processor, and a display means; and a client node configured to communicate in real time through the web-server with the hand-held device, the method comprising the steps of inputting a base data by the hand0-held device via the internet, the data representing selection of one a commodity and service; the features including price of the Selected Commodity or product displayed on the web server transmitted to the hand-held device in the form of animated characters; transmitting an offered price data to the client node through the web Server by the hand-held device, determining the acceptability or otherwise of the offered price of the client node and retransmitting via the web server the result of said determination to the hand-held device; and transferring the commodity or services under the agreed condition upon selection of settlement terms on consideration criterion to the user of the hand-held device by the user of the client node.

### FIELD OF INVENTION

The present invention relates to the field of data transmission through communication network. More particularly, the present invention relates to a system and method for receiving, processing, and transmitting data between plurality of nodes through communication networks.

### BACKGROUND OF THE INVENTION

Commercial sites on the Internet (in particular on the World Wide Web) are known. Typically, websites where exchangeable merchandise or services are defined by a static description of the goods or services being offered, the consideration at which such commodities or services are being offered and acceptable format from an offeree including details of consideration amount and settlement data. In other words, such commercial sites operate transaction based on fixed or pre-disclosed data.

Such sites are therefore not suited for the exchange of goods or services that are negotiable, including unique, surplus, high-volume or discontinued items or negotiable services. The known commercial websites are interactive only to the extent that a potential recipient is able to select a particular commodity for purchase and access to data relating to payment and shipment. Such websites include so-called “auction” sites such as Net Market (R) (www.netmarket.com) which users may consecutively input prices they are willing to pay for specific products. The product or services is then transferred to the customer bidding offerer the highest consideration amount. Such “auction” websites do not allow the user to negotiate with the offerer.

US publication no 20050033660 discloses a system and method for selling goods and/or services at negotiable prices over a distributed computer network such as the Internet. The cited invention provides an interactive computer-implemented system such as a site on the World Wide Web where simulated human merchants present goods for sale at negotiable prices and interact or “haggle” with customers until either an agreed price is arrived at or one party terminates the negotiation process. A customer or user of the system engages in discussion with the simulated merchant in connection with the input of a monetary offer for the desired merchandise. The user selects a dialog window designed to get the merchant into the best possible “mood” as an effort to get the merchant to accept the user's offer. Each merchant will react to commentary input by a user in a manner determined by a database engine taking into account various factors such as prior user information, merchant characteristics and historical information such as a the outcome of recent “haggles” conducted by the merchant.

U.S. Pat. No. 7,440,912 described to systems and methods for implementing automated auction processes that may be conducted electronically. According to the cited invention, a computer-based processing system is disclosed for implementing several auction processes that may be each held at an auction site on the Internet at a designated time and data. A sample auction process may control and display an animated automated character in the role of an auctioneer. Product information relating to an item or group of items being auctioned may also be displayed. After the animated auctioneer announces the start of the auction, the auction process may receive bids from multiple bidders participating in the auctioning of the item(s). The animated auctioneer may continue to announce the current bid based on the received bids until bidding appears to have stopped by virtue of the fact that there have been no additional bids after the expire of a predetermined amount of time from the last bid. The server processor is adapted to select the animated auctioneer from a set of genre-based characters.

U.S. Pat. No. 7,904,346 describes a system to conduct price negotiations between a buyer and a seller by a network-based commerce system. The cited invention provides an auction method to present an auction purchase process and a fixed price purchase process for purchasing a seller's offering to a buyer where the smaller may adjust a seller fixed-price offer during the auction. This invention described auction based purchase process.

Publication no US 20010032164 teaches a method and apparatus for bi-directionally auction using a computer network. The method described herein includes displaying one or more purchase prices one or more buyers are willing to pay for goods and a higher-price-accumulated purchase quantity for each purchase price. The higher-price-accumulated purchase quantity is equal to the number of goods registered at or above the corresponding purchase price. One or more buyers participate competitively for a desired (higher) purchase price by referring to each displayed purchase price and higher-price-accumulated purchase quantity. A transaction is confirmed between the seller who has goods to sell in sufficient quantity and who first selects a displayed purchase price and higher-price-accumulated purchase quantity. The seller than sells to all buyers at or above the selected purchase price.

US publication no 2010262478 teaches to a system and method for providing complete electronic commerce (“E-Commerce”) transactions and solutions for a marketing company's products via the World Wide Web, including facilities for signing up new customers and recruiting, training and supporting new independent business owners through an interactive online process. This patent is based on quasi MLM.

US publication no 20090292647 is directed to: (1) a single buyer-multiple seller electronic auction methodology in which multi- attribute adjustments to buyer requests or seller offers are made in real time in response to near-perfect information for both the buyer and the sellers; (2) a comprehensive, unified system that minimizes the entire chain of transaction costs from first desire to buy, through education, search, bargaining, and finally to the sale itself, and (3) a business model to produce and sell near-perfect proprietary information about the buyer and the sellers that derives directly and exclusively from the auction process, The total effect is to produce near-perfect, frictionless, competitive markets. This is a system of many sellers and one buyer.

U.S. Pat. No. 7,945,481 discloses a network based systems which comprises a remote server accessible via a network by client computers utilizing client software such as browsers for interfacing with the remote server.

Thus in view of the prior art stated above, there exists a need in the art for a dynamic and interactive system and method for selling which is capable of selling articles and/or goods that gives buyers and option to negotiate prices.

### OBJECTS OF THE INVENTION

It is therefore an object of the present invention to propose a method of electronically conducting exchange of goods and services at negotiable terms over a communication network.

Another object of the present invention is to propose a method of electronically conducting exchange of goods and services at negotiable terms over a communication network, which allows a two way interaction between an offerer and offeree to conduct negotiations on settlement conditionalities.

A still another object of the present invention is to propose a method of electronically conducting exchange of goods and services at negotiable terms over a communication network, which can be implemented through a hand held device or a computer over the internet.

A further object of the present invention is to propose a method of electronically conducting exchange of goods and services at negotiable terms over a communication network, which is geographically un-restricted, economic, efficient, and easy-to-implement.

### SUMMARY OF THE INVENTION

The present invention provides propose a method of electronically conducting exchange of goods and services at negotiable terms over a communication network. According to the invention, a prospective offerree is enabled to select the price of an exchangeable product as per his/her choice and the offer has an option to sell the article/goods as per the price selected/chosen by the buyer. Thus the selected price is determined by the buyer and accepted or otherwise by the seller.

In an embodiment, the price of the article/good is based on a value associated with the product as exhibited including a negotiated price between the two based on data displayed in animated character the allows a two way interaction between the buyer and seller for price negotiations.

The present invention allows users to wish a price for the product only once in day and also there are no elements of mood of the buyer, past behavior etc.

The present invention provides a method of selling goods/articles by one seller to multiple buyers.

### BRIEF DESCRIPTION OF THE ACCOMPANYING DRAWINGS

It is to be noted, however, that the appended drawings illustrate only typical embodiments of this invention and are therefore not to be considered for limiting of its scope, for the invention may admit to other equally effective embodiments.

FIG. 1 shows a method of selling and buying articles and/or goods at negotiable prices through a Web, Wap, Mobile and client applications.

FIG. 2 shows a method of selling and buying articles and/or goods at negotiable prices through a hand held device.

### DETAILED DESCRIPTION OF THE INVENTION

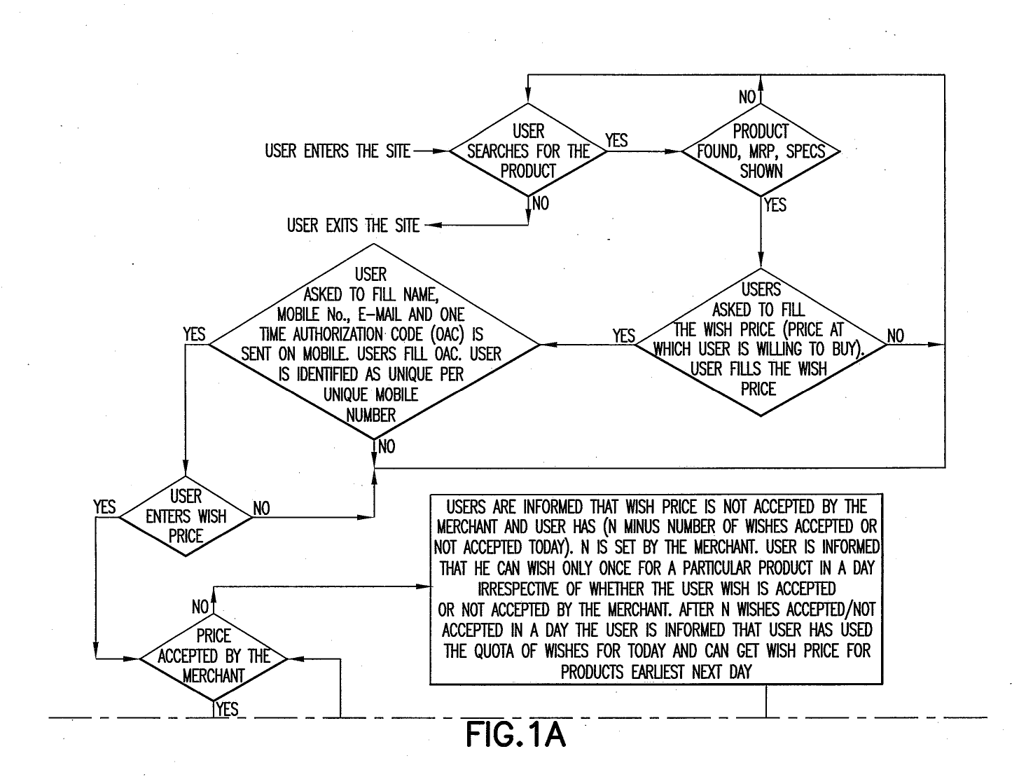

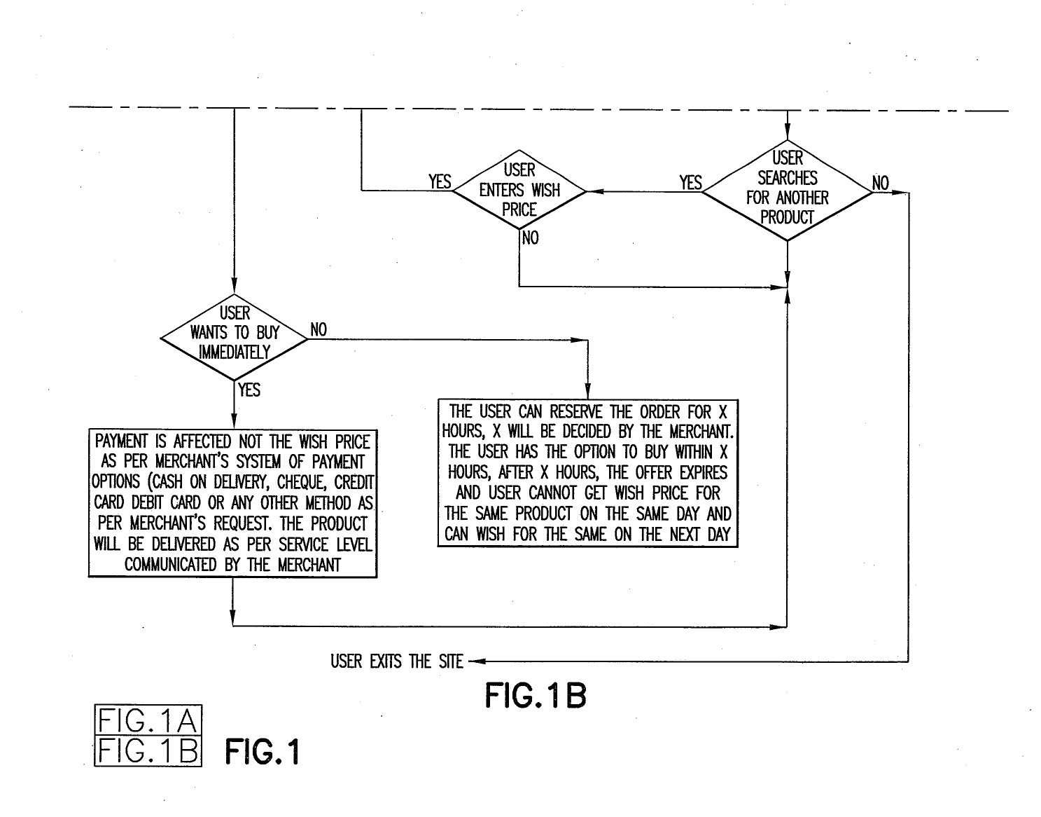

Reference may be made to the FIG. 1 which shows a method of selling and buying articles and/or goods at negotiable prices through a Web, Wap, Mobile and client applications. Accordingly the buyer gets an option to select the price of the article/good as per his/her choice and the seller has an option to sell the article/good as per the price selected/chosen by the buyer. Thus the selected price is determined by the buyer and accepted by the seller.

The price of the article/good is based on the value associated with product as per buyer which he exhibited through the selected price window. The seller sells it at the selected price or rejects the offer. The present invention allows the buyer to select the price with the animated character that allows a two way interaction between the buyer and seller for price negotiations.

According to the method, the buyer inputs his base data and one time authorization code is sent to him on his hand held device for use of the service. After entering the data, the customer locates his model of choice using the device having at least one input unit, a processing unit and a display. Buyer selects the product and an animated character appears and displays the features/ details/price of the product.

The present invention provides a system and method in which at least one buyer is granted with his/her desired price of the article/good. At least one selected buyer inputs his desired price for the article/good. If the selected price is within a predefined rage, then the buyer gets the article/good at the selected price or else it is declined. In a day, N wishes can be granted/declined. The same buyer is not allowed to choose the price as per his/her choice again for the same product if his/her price is selected. If the buyer's price is not accepted, it can be inputted again by the same/other buyer. Once the price is accepted, the payment is made by the buyer and the article/good is shipped to the address provided by the buyer in the base data. The buyer makes payment online using payment gateways before the shipping of the article/good. Alternatively, the payment can be also made through cash/cheque after receiving the product.

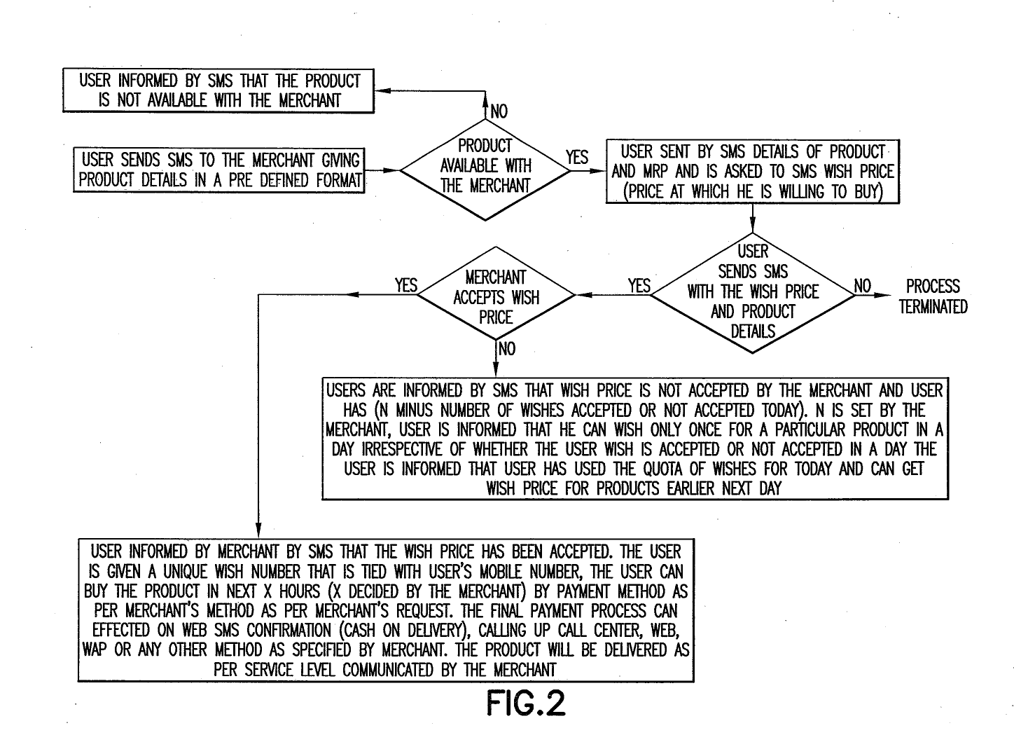

FIG. 2 shows a method of selling and buying articles and/or goods at negotiable prices using a hand held device. The buyer sends SMS to the seller giving product details in a pre defined format. If the product is available with the seller, the buyer send the details of article and MRP through a second message. The buyer is asked by the seller to message the desired price at which he is willing to buy. The buyer sends the message including the quote price and product details.

If the seller accepts the quoted price, the buyer is informed by the merchant through a message over the hand held device that the desired price has been accepted. The buyer is given a unique number which is tied with the buyer's mobile number. The buyer is able to get the article/good delivered in next x hours. The payment of the article/good is made through such as but note limited to the cash on delivery, cheque, credit card, debit card or any other method as per merchant's request. The payment can also be effected on Web, SMS confirmation (cash on delivery), calling up call centre, Web, Wap or any other method as specified by Merchant. The product will be delivered as per service level communicated by the seller/buyer.

Alternately, if the seller does not accept the quoted price, the buyers are informed through a message that the quoted price is not accepted by the seller. Buyer is informed that he can quoted at least only once for a particular product in a day irrespective of whether the buyers quoted price is accepted or not accepted by the seller. After N wishes are accepted/rejected in a day, the buyer is informed that the buyer has used his allotted chances for today and can further submit quote earliest on the next day.

If the good/ article is not available, the seller informs the buyers through a message.

The buyer's data includes such as but not limited to the ID, password, name, resident registration number, zip code, address, emergency contact, E-mail, new purchase registration list, bonus points, current purchase registration list, purchase results list, bonus points, credit rating and other items which are stored at the sellers database.

The address filed may include such as but not limited to the home address or a recipient address. The emergency contact filed may include such as but not limited to the telephone number, mobile phone, or page number.

The above may be considered as exemplary embodiment.

It is to be understood that the above-described embodiments are illustrative of only a few of the many possible specific embodiments, which can represent applications of the principles of the invention. However, numerous and varied other arrangements can be readily devised in accordance with these principles by those skilled in the art without departing from the spirit and scope of the invention.

1. A method of electronically conducting virtual exchange under negotiation of goods and services in a system over a communication network, the system comprising:
a web server displaying detailed data in respect of exchangeable commodity or services;
a hand-held device enabled to access the web server via internet, the device having at least one input means, a processor, and a display means; and
a client node configured to communicate in real time through the web server with the hand-held device, the method comprising the steps of:
inputting a base data by the hand-held device via the internet, the data representing selection of one of a commodity and service, wherein
features include price of the selected commodity or product displayed on the web server transmitted to the hand-held device in the form of animated characters;
transmitting an offered price data to the client node through the web server by the hand-held device;
determining an acceptability or otherwise of the offered price by the client node and retransmitting via the web server a result of said determination to the hand-held device; and
transferring the commodity or services under an agreed condition upon selection of settlement terms on consideration criterion to a user of the hand-held device by a user of the client node.

2. The method as claimed in claim 1, wherein the hand-held device is a mobile device.

3. The method as claimed in claim 1, wherein when the determination of the offered data is not acceptable to the client node, a rejection communication is transmitted to the hand-held device.

4. The method as claimed in claim 1, wherein a pre-defined number of offered data can be transmitted for determination by the client node in a specified period.

5. The method as claimed in claim 1, wherein the hand-held device is initially logged-on to the web server based on identification data, and wherein the client device upon authentication of the identification data transmits a transaction code to the hand-held device.

6. (canceled)
